(19) United States
(12) Patent Application Publication
(10) Pub. No.: US 2021/0365122 A1
(43) Pub. Date: Nov. 25, 2021

(54) DEVICE AND METHOD FOR GENERATING HAPTIC DATA, AND DEVICE AND METHOD FOR PROVIDING HAPTIC EFFECT

(71) Applicant: CK MATERIALS LAB CO., LTD., Seoul (KR)

(72) Inventors: Hyeong Jun KIM, Seoul (KR); Jong Hun LEE, Seoul (KR); Ki Suk SON, Seoul (KR)

(21) Appl. No.: 17/059,249

(22) PCT Filed: Nov. 7, 2019
(86) PCT No.: PCT/KR2019/015010

§ 371 Date: Nov. 26, 2020

(30) Foreign Application Priority Data
Nov. 16, 2018 (KR) 10-2018-0142103

(51) Int. Cl. G06F 3/01; G08B 6/00; A63F 13/285

(52) U.S. Cl. CPC G06F 3/016; G08B 6/00; G10L 25/18; G06F 2203/013; A63F 13/285

(57) ABSTRACT

Disclosed are a device and method for generating haptic data, and a device and method for providing a haptic effect. The device for generating haptic data comprises: a controller for generating haptic data about an event occurring during game play on the basis of haptic data settings information; and a communication unit for transmitting the generated haptic data to the device for providing a haptic effect. The device for providing a haptic effect comprises: a communication unit for receiving the haptic data from the device for generating haptic data; a haptic effect playback unit for generating the haptic effect under the control of the controller; and a controller for controlling the generation of the haptic effect on the basis of the haptic data.

### TECHNICAL FIELD

The following embodiments relate to a haptic data generating technology and a haptic effect providing technology.

### BACKGROUND ART

Game developers use visual and auditory effects to provide an immersive game play. For example, when a user plays a game on a smartphone, a visual effect for a game event is provided through a screen or an auditory effect for the game event is provided through a speaker or earphone. In addition, in recent years, a vibration effect is sometimes used to increase the sense of experience for the game event. As prior art, Korean Patent Publication No. 1998-0032560 ‘Operating Device and Game Device for Game Machines’ discloses an operating device for a game machine including a response member operated to perform feedback to a user in the form of vibration, sound, light, or a combination thereof.

### DISCLOSURE

### Technical Solution

A device for generating haptic data linked with a game program according to an embodiment may include: a controller generating haptic data for an event occurring during game play based on haptic data setting information; and a communication unit transmitting the generated haptic data to a haptic effect providing device.

The event may include at least one of a game content event occurring on a game content of the game program and a user input event for a user input input for the game play.

The haptic data setting information may include setting information for at least one of an application range of a haptic effect, a haptic pattern, and a haptic strength.

When one or more content events selected by a user occur, the communication unit may transmit haptic data corresponding to the game content event which occurs.

The controller may perform the fast Fourier transform processing for the audio data corresponding to each event, select a target frequency band of the audio data based on the result of performing the fast Fourier transform processing, perform filtering for the selected target frequency band by using the bandpass filter, perform the inverse fast Fourier transform processing for the audio data in the target frequency band in which the filtering is performed, and determine the haptic pattern corresponding to the event based on the threshold in the result of performing the inverse fast Fourier transform processing.

The controller may perform the fast Fourier transform processing for the audio data corresponding to the event, extract a frequency in which a result value of performing the fast Fourier transform processing is largest, and generate the haptic data based on the haptic strength corresponding to the extracted frequency.

The haptic data may include a first element indicating the type of message, a second element indicating a size of a message value, and a third element including message information.

The controller may generate haptic data to be provided to a plurality of users which performs the game play together.

The device for generating haptic data according to an embodiment may further include a USB host transmitting, when the haptic data generating device is connected to the haptic effect providing device by wire through a cable, power and the haptic data to the haptic effect providing device through the cable.

A device for providing a haptic effect according to an embodiment may include: a communication unit receiving haptic data from a haptic data generating device; a haptic effect generating unit generating the haptic effect under the control of a controller; and the controller controlling the generation of the haptic effect based on the received haptic data, in which the haptic data may be associated with an event which occurs during game play and generated based on haptic data setting information.

The controller may generate haptic pattern data using information on a haptic pattern index and a haptic strength included in the haptic data and control the generation of the haptic effect based on the haptic pattern data.

The controller may generate the haptic pattern data based on a haptic pattern duration corresponding to the haptic pattern index.

The device for providing a haptic effect according to an embodiment may further include a lighting effect reproducing unit generating a lighting effect under the control of the controller, in which the controller may control the generation of the lighting effect based on the haptic data.

The controller may extract information on the haptic strength from the haptic data and determine at least one of a lighting color and a lighting strength based on the information on the haptic strength.

A method for generating haptic data linked with a game program according to an embodiment may include: generating haptic data for an event occurring during game play based on haptic data setting information; and transmitting the generated haptic data to a haptic effect providing device.

A method for providing a haptic effect according to an embodiment may include: receiving, from a haptic data generating device, haptic data associated with an event occurring during game play; generating haptic pattern data based on the haptic data; and generating a haptic effect based on the haptic pattern data, in which the haptic data may be generated based on haptic data setting information.

### Advantageous Effects

According to an embodiment, it is possible to provide a haptic effect and/or a lighting effect linked to a game program through a wearable device, a game controller, or a mobile device accessory device when a user plays a game.

According to an embodiment, it is possible to provide the haptic effect and/or the lighting effect simultaneously to various users who are playing the same game.

### DESCRIPTION OF DRAWINGS

FIG. 1 is a diagram illustrating a haptic effect providing system according to an embodiment.

FIG. 2 is a diagram illustrating a haptic effect providing system according to another embodiment.

FIG. 3 is a flowchart for describing an example of setting haptic data according to an embodiment.

FIG. 4 is a flowchart for describing an example of determining a haptic pattern based on audio data of a game program according to an embodiment.

FIG. 5 is a diagram illustrating elements of haptic data according to an embodiment.

FIG. 6 is a flowchart for describing an operation of a method for generating haptic data according to an embodiment.

FIG. 7 is a flowchart for describing an operation of a method for providing a haptic effect according to an embodiment.

### BEST MODE

Hereinafter, embodiments will be described in detail with reference to the accompanying drawings. However, various changes may be made to the embodiments, and thus the scope of the patent application is not limited or limited by these embodiments. It should be understood that all changes, equivalents, or substitutes to the embodiments are included in the scope of the rights.

The terms used in the examples are used for illustrative purposes only and should not be interpreted as limiting. A singular form may include a plural form if there is no clearly opposite meaning in the context. In the present application, it should be understood that term “include” or “have” indicates that a feature, a number, a step, an operation, a component, a part or the combination thereof described in the specification is present, but does not exclude a possibility of presence or addition of one or more other features, numbers, steps, operations, components, parts or combinations thereof, in advance.

If not contrarily defined, all terms used herein including technological or scientific terms have the same meanings as those generally understood by those skilled in the art. Terms which are defined in a generally used dictionary should be interpreted to have the same meaning as the meaning in the context of the related art, and are not interpreted as an ideal meaning or excessively formal meanings unless clearly defined in the present application.

In addition, in the description with reference to the accompanying drawings, the same components are assigned the same reference numerals regardless of the reference numerals, and redundant descriptions thereof will be omitted. In describing the embodiment, a detailed description of related known technologies will be omitted if it is determined that they make the gist of the embodiment unclear.

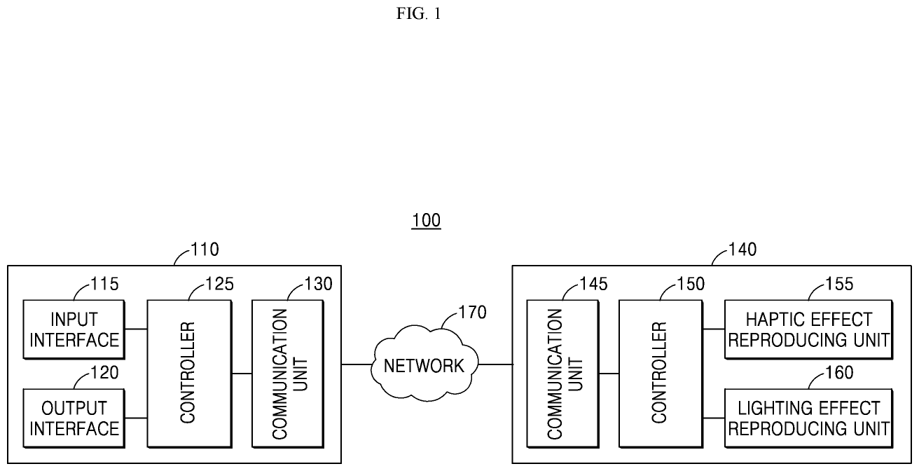

FIG. 1 is a diagram illustrating a haptic effect providing system according to an embodiment.

A haptic effect providing system 100 provides a haptic effect and/or a lighting effect to a user when the user plays a game program in link with the game program. Therefore, the user may feel a higher sense of immersion and fun. For example, the haptic effect providing system 100 may provide a haptic effect to the user according to the timing at which a game character shoots a gun or the game character is struck in game play, through which the user may receive a feel as if actually shooting the gun or striking is made. As another example, the haptic effect providing system 100 may generate haptic pattern data corresponding to a sound pattern of audio data by analyzing audio data output from a game and provide the haptic effect to the user based on the generated haptic pattern data.

Referring to FIG. 1, the haptic effect providing system 100 according to an embodiment includes a haptic data generating device 110 and a haptic effect providing device 140. The haptic data generating device 110 as a device that generates the haptic data in link with the game program may correspond to a mobile device such as a personal computer or a smartphone, for example. The haptic data generating device 110 may generate haptic data corresponding to game contents by analyzing the game contents and the haptic data may include haptic pattern data defining a pattern of the haptic effect to be provided to the user. The haptic data generating device 110 may operate to be included in a device in which the game program is driven.

The haptic effect providing device 140 is a device that provides a haptic effect (or haptic stimulus) and/or a lighting effect to the user based on the haptic data transferred from the haptic data generating device 110. The haptic effect providing device 140 may also be referred to as a ‘haptic device’. The haptic effect providing device 140 may play back the haptic data and express a haptic feedback such as vibration or tapping and provide a haptic stimulus having a specific pattern to the user. The haptic effect providing device 140 may have any one form of a wearable device, a mobile device accessory device, a game console controller, a game pad, a keyboard, a mouse, and a joystick, for example, but the form is not limited thereto. The haptic effect providing device 140 includes a device linked with the device in which the game program is driven.

In an embodiment, when an event occurs on the game play, the haptic data generating device 110 may generate the haptic data corresponding to the game content and transmit the generated haptic data to the haptic effect providing device 140. The haptic effect providing device 140 may play the haptic data received from the haptic data generating device 110 to provide the haptic effect to a user, and additionally provide the lighting effect and a sound effect related to the game contents to the user. The haptic effect providing device 140 may comprehensively provide the haptic effect, the lighting effect, and the sound effect for the event to the user. The user may receive the haptic effect and/or the lighting effect through a wearable device, the keyboard, or the mouse while playing the game through the personal computer or the smartphone. In this case, the user is provided with not a haptic effect of a simple pattern, but a haptic effect of various patterns linked to the game content. In some embodiments, the haptic effect providing system 100 may provide the haptic effect and/or the lighting effect simultaneously to various users who play the same game.

In an example, when the user plays the game alone or several users play the game together, it is assumed that the user playing the game wears the wearable device in the form of a watch or a band. When an event such as gunshot or kick occurs in the game program, haptic pattern data corresponding to the event is played in the wearable device to generate the vibration, and a lighting effect reproducing unit (e.g., LED) provided in the wearable device may be driven. Therefore, the game play immersion and enjoyment by the user may be enhanced. Further, since the user may feel the haptic effect while hearing audio related to the game content, an effect of the game may be maximized. Further, it is possible to effectively transfer the game effect on the game content to a user who may not hear the audio, such as a hearing impaired user through the haptic effect or the lighting effect.

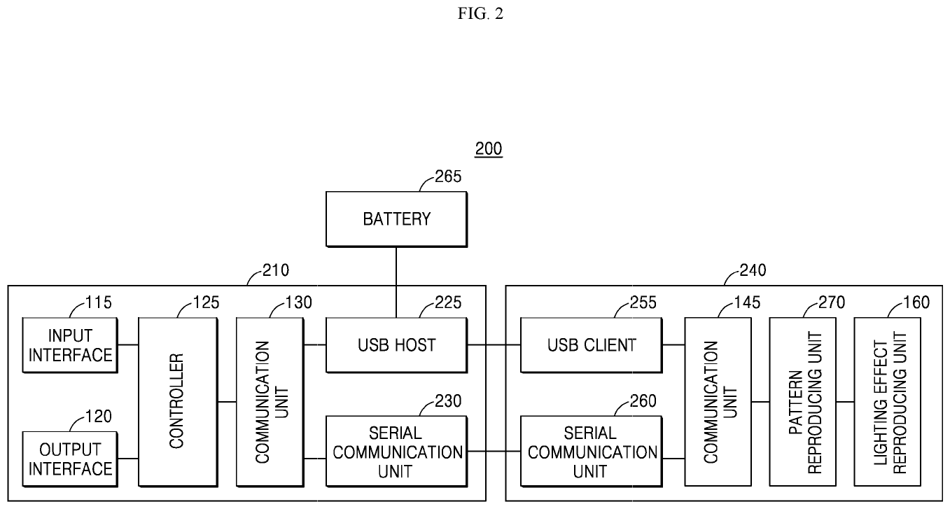

As illustrated in FIG. 1, the haptic data generating device 110 and the haptic effect providing device 140 may be wirelessly connected through a network 170 or wired through a cable as illustrated in FIG. 2. The haptic effect providing system 200 illustrated in FIG. 2 will be described below.

The haptic data generating device 110 includes a controller 125 and a communication unit 130. In some embodiments, the haptic data generating device 110 may further include an input interface 115 and an output interface 120. The input interface 115 receives a user input. For example, the input interface 115 may receive touch data of the user through a touch screen display and transmit the received touch data to the controller 125. The output interface 120 may play audio data related to the game content and output audio through a speaker or earphone.

The controller 125 may control an operation of the haptic data generating device 110 and include one or more processors. In some embodiments, the controller 125 may control the game program. In this case, the controller 125 controls the start and end of the game program, communication linkage with the haptic effect providing device 140, and event processing.

The controller 125 generates the haptic data for the event that occurs during the game play. Here, the event includes one or more of a game content event occurring on the game content of the game program and a user input event for a user input input for the game play. The game content event includes, for example, a case where a game character is damaged or a specific game object appears on the game content. The user input event includes, for example, a case where the user applies a touch input on the touch screen display to manipulate the game character.

The game content event may be an event which occurs by the user input event. For example, the game character is manipulated by the user input event such as the touch input of the user and when a change in game content thus occurs (e.g., a specific game object is detonated), the change in game content corresponds to the game content event. In some embodiments, the game content event may also include an event such as an alarm for a specific situation on the game content, such as an alarm for a dangerous moment of the game character. Such a haptic effect applied to various events may help the user to better play the game, and accordingly, the user may further enhance a game play ability.

In an embodiment, the controller 125 may generate the haptic data based on haptic data setting information. The haptic data setting information may include setting information for at least one of an application range of the haptic effect, the haptic pattern, and a haptic strength which may be determined by the user input. The user may directly set the application range of the haptic effect, the haptic pattern, and/or the haptic strength on the game program, or the haptic data may be set according to setting information designated by a developer of the game program. The user may select one or more game content events to which the haptic effect is to be applied and also set the haptic strength to be applied to each game content event or user input event. In this case, the controller 125 may generate the haptic data based on the haptic strength set by the user in some embodiments.

In an embodiment, the controller 125 may generate the haptic data based on the audio data corresponding to each event. The controller 125 processes the haptic pattern for each period set at the time when audio data is transmitted. As a more specific example, the controller 125 may perform fast Fourier transform (FFT) processing on the audio data of the game program and select a target frequency band of the audio data based on a result of performing the FFT processing. For example, the controller 125 may select a frequency band including a frequency in which a value in which the FFT processing is performed is largest as the target frequency band. Thereafter, the controller 125 may perform filtering for the target frequency band by using a bandpass filter and perform inverse fast Fourier transform (IFFT) processing for the audio data in the target frequency band in which the filtering is performed. The controller 125 may determine the haptic pattern based on a threshold in the result of performing the IFFT processing. For example, the controller 125 may convert data of which filtering is performed into a time domain through the IFFT processing, extract data values of the threshold or more from the data converted into the time domain, and then, add the extracted data values in units of a specific time interval. The controller 125 may determine the haptic pattern corresponding to the event by determining that the haptic effect occurs when a result of adding the data values satisfies a specific condition. Further, the controller 125 may extract a frequency in which the result value of performing the FFT processing for the audio data corresponding to the event of the game program is largest and generate the haptic data based on the haptic strength corresponding to the extracted frequency. The haptic strength corresponding to a magnitude of each frequency may be defined in advance.

The communication unit 130 transmits the haptic data to the haptic effect providing device 140 through the network 170. For example, when receiving the haptic data from the controller 125, the communication unit 130 may transmit the haptic data by using Bluetooth, Bluetooth Low Energy (BLE), Wi-Fi, and Long Term Evolution (LTE). When, for example, the game content event or the user input event occurs, the communication unit 130 may transmit the haptic data corresponding to each event to the haptic effect providing device 140. Alternatively, when one or more game content events selected by the user in the haptic data setting information occur, the communication unit 130 may transmit the haptic data corresponding to the game content event which occurs to the haptic effect providing device 140.

The haptic effect providing device 140 includes a communication unit 145, a controller 150, and a haptic effect reproducing unit 155. In some embodiments, the haptic effect providing device 140 may further include a lighting effect reproducing unit 160.

The communication unit 145 receives the haptic data to the haptic data generating device 110 through the network 170. The haptic data may be associated with the event which occurs during the game play and may be generated based on the haptic data setting information. The haptic data may include data regarding the haptic pattern.

The controller 150 may control the operation of the haptic effect providing device 140 and include one or more processors. The controller 150 controls the occurrence of the haptic effect based on the received haptic data. The controller 150 may generate haptic pattern data using information on a haptic pattern index and a haptic strength included in the haptic data, and control the occurrence of the haptic effect based on the haptic pattern data. The controller 150 may generate the haptic pattern data based on a haptic pattern duration corresponding to the haptic pattern index.

The haptic effect reproducing unit 155 reproduces the haptic pattern data under the control of the controller 150 and generates the haptic effect. The haptic effect reproducing unit 155 may include one or more actuators that generate the haptic stimulus.

The lighting effect reproducing unit 160 generates the lighting effect under the control of the controller 150. For example, the lighting effect reproducing unit 160 may include a lighting device such as an LED. The controller 150 may control the occurrence of the lighting effect based on the haptic data. For example, the controller 150 may extract information on the haptic strength from the haptic data and determine at least one of a lighting color and a lighting strength based on the extracted haptic strength information. For example, the controller 150 may display a red lighting more brightly as the haptic strength is stronger, and may display a blue lighting brighter as the haptic strength is weaker.

FIG. 2 is a diagram illustrating a haptic effect providing system according to another embodiment.

Referring to FIG. 2, the haptic effect providing system 200 according to another embodiment includes a haptic data generating device 210 and a haptic effect providing device 240. Unlike the haptic effect providing system 100 illustrated in FIG. 1, the haptic data generating device 210 and the haptic effect providing device 240 may be wiredly connected to each other through the cable or the like. The haptic data generating device 210 may further include a Universal Serial Bus (USB) host 225 and/or a serial communication unit 230 connected to the communication unit 130, and the haptic effect providing device 240 may further include a USB client 255 and/or a serial communication unit 260 connected to the communication unit 145. For example, the haptic data generating device 210 and the haptic effect providing device 240 may communicate with each other through a connection between the USB host 225 and the USB client 255 or a connection between the serial communication unit 230 and the serial communication unit 260. The serial communication unit 230 and the serial communication unit 260 may be connected to each other through a serial type interface such as Recommended Standard (RS)-232, for example. A pattern reproducing unit 270 of the haptic effect providing device 240 may extract the haptic pattern index and the haptic strength from the received haptic data, and generate the haptic pattern data using the extracted haptic pattern index and haptic strength. The pattern reproducing unit 270 may reproduce the haptic pattern by driving the actuator based on the generated haptic pattern data. The pattern reproducing unit 270 may include a function of the haptic effect reproducing unit 155 of FIG. 1.

When the haptic data generating device 210 is connected to the haptic effect providing device 240 by wire through the cable, the USB host 225 may transmit power and haptic data to the haptic effect providing device 240 through the cable. In this case, the haptic effect providing device 240 may simultaneously receive power which may be used for driving the actuator together with the haptic data from the haptic data generating device 210. In one embodiment, the haptic data generating device 210 may be included in the smartphone and driven, and in this case, the haptic effect providing device 240 may be a haptic patch for a game that may be attached to the smartphone. At this time, the USB host 225 may be, for example, a charging jack interface, and when the haptic data generating device 210 and the haptic effect providing device 240 are connected by wire, the power may be supplied from a charging portion of the smartphone to the haptic effect providing device 240 and at the same time, the haptic data may be transferred.

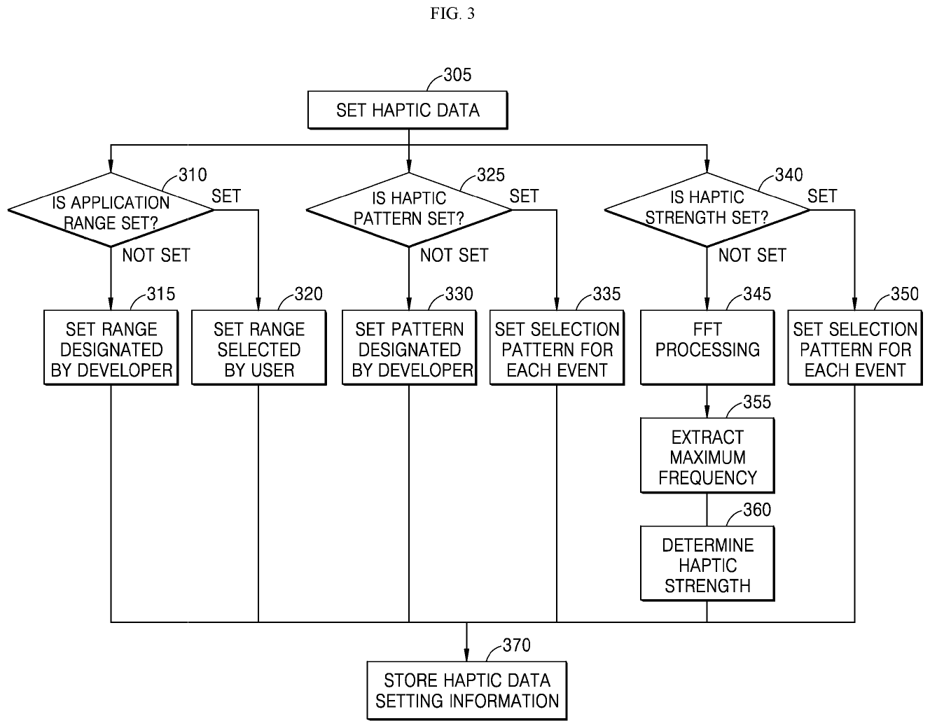

FIG. 3 is a flowchart for describing an example of setting haptic data according to an embodiment.

Referring to FIG. 3, in an embodiment, the user may set the haptic data through a setting interface provided in a game program (i.e., game menu) (305). For example, the user may set the application range of the haptic effect, the haptic pattern, and the haptic strength through the setting interface. When the haptic effect is set for each event, the haptic effect may be set for each game content event depending on a situation of an internal game program or for each user input event by the user input. In an embodiment, the audio data of the game content may be present in all events. For example, audio data (e.g., sound effect) corresponding to each of the game content event and the user input event may be present.

The user may determine whether to set the application range of the haptic effect through the setting interface (310). The application range of the haptic effect indicates a haptic effect processing range for the event. When the application range is not set (i.e., not set), the application range of the haptic effect is set to a range designated by a developer (game program developer) (315). In contrast, when the user sets the application range, the application range of the haptic effect is set to the range set by the user (320). In an embodiment, in the basic setting on the game program, the application range of the haptic effect may be set to the range designated by the developer. The user may determine whether to generate the haptic effect for each event through the setting interface on the game program. The game program may generate the haptic effect to the application range determined by the user.

Furthermore, the user may determine whether to set the haptic pattern through the setting interface (325). When the user does not set the haptic pattern, the haptic pattern is set to a haptic pattern designated by the developer (330). The user may select the haptic pattern for each event and in this case, a haptic pattern corresponding to the corresponding event is set for the event selected by the user (335). For an event not selected by the user, the haptic pattern may be set to the haptic pattern provided by the developer.

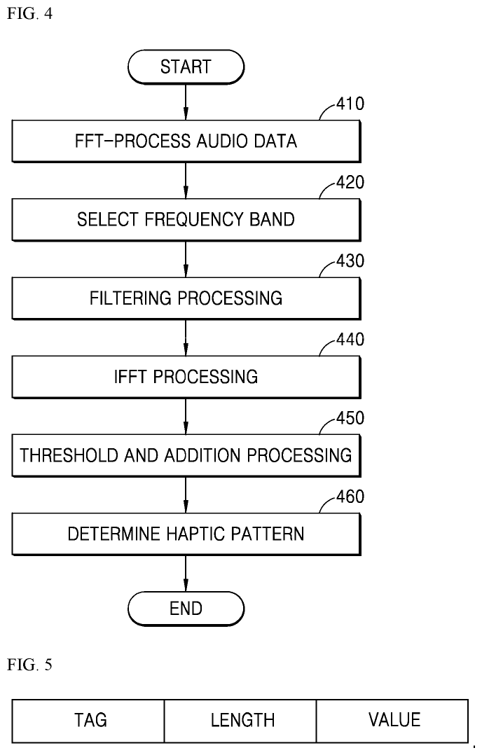

When the user does not set the haptic pattern for a specific event, the haptic pattern designated by the developer may be determined based on the audio data corresponding to the event. For example, the haptic pattern may be determined through a series of processing processes such as Fast Fourier Transformation (FFT) processing, selection of a target frequency band, bandpass filtering processing, and haptic pattern extraction using a threshold for the audio data. This will be described in more detail in FIG. 4.

Furthermore, the user may determine whether to set the haptic strength for each event through the setting interface (340). When the user does not set the haptic strength, the haptic strength is set to the haptic strength which the developer designates for each haptic effect. The user may select the haptic strength of the haptic effect for each event and in this case, a haptic strength corresponding to the corresponding event is set for the event selected by the user (350). For an event not selected by the user, the haptic strength may be set to a predefined haptic strength.

When the user does not set the haptic strength for a specific event, the haptic data generating device may perform FFT processing for audio data (e.g., sound effect) corresponding to the corresponding event (345). The haptic data generating device may extract a maximum frequency (e.g., a frequency in which dB is largest) having a largest value from an FFT processing result (355). The haptic data generating device may determine the haptic strength corresponding to the event based on the extracted maximum frequency (360). The haptic data generating device may determine the haptic strength corresponding to the maximum frequency as the haptic strength corresponding to the corresponding event. The haptic strength corresponding for each frequency may be predefined as shown in Table 1 below, for example.

TABLE 1

| | |
|---|---|
| Frequency range | Haptic strength |

| | | |
|---|---|---|
| 1 to 50 | Hz | 1 |
| 51 to 150 | Hz | 2 |
| 151 to 200 | Hz | 3 |
| 201 to 300 | Hz | 4 |
| 301 to 400 | Hz | 5 |
| 401 to 500 | Hz | 6 |
| 501 to 800 | Hz | 7 |
| 801 to 1000 | Hz | 8 |
| 1001 to 2000 | Hz | 9 |
| 2001 to 40000 | Hz | 10 |

For example, as a result of FFT processing of audio data corresponding to event A, assuming that the maximum frequency with the largest FFT conversion value is 240 Hz, the haptic strength corresponding to the event A may be determined as haptic strength ‘4’ in a frequency range including a frequency of 240 Hz.

When the user selects the haptic strength, the haptic strength may be determined for each event as shown in Table 2 below, with a martial art game as an example. A duration which the developer designates for each event is determined as a duration of the haptic pattern.

TABLE 2

| | | Haptic | Haptic pattern |
|---|---|---|---|
| No | Event | strength | duration (ms) |
| 1 | Fist/kick strike of game character | 3 | 500 |
| | manipulated by user is hit (strike | | |
| | sound) | | |
| 2 | Last strike/bat strike of fist combo | 5 | 1000 |
| | of game character is hit (heavy | | |
| | strike sound) | | |
| 3 | Pistol/dagger shoot of game | 4 | 1000 |
| | character (sharp metal sound) | | |
| 4 | Game character is hit by enemy | 7 | 500 |
| | (weak strike sound) | | |
| 5 | Game character down/killed by | 3 | 2000 |
| | enemy attack (large and strong | | |
| | vibration) | | |

According to such a process, when at least one of the application range of the haptic effect, the haptic pattern, and the haptic strength is set, the set contents may be stored in haptic data setting information (370). After the haptic data setting information is stored (370), the haptic data is generated based on the haptic data setting information after the game play starts. According to the above embodiment, it is possible to provide the haptic effect by processing the audio data corresponding to the event without setting the haptic effect separately for each event.

FIG. 4 is a flowchart for describing an example of determining a haptic pattern based on audio data of a game program according to an embodiment.

Referring to FIG. 4, in step 410, the haptic data generating device may perform fast Fourier transform (FFT) processing for the audio data of the game program. In an embodiment, the haptic data generating device may first split the audio data into a random number of data string types in order to perform the FFT processing for the audio data. For example, the haptic data generating device may split the audio data into 256 or 1024 data columns in order to smoothly perform the FFT processing for the audio data. Here, the number of data columns is not limited to the above example. The audio data may be converted into the frequency domain from the time domain by the FFT processing.

In step 420, the haptic data generating device may select the target frequency band of the audio data based on the result of performing the FFT processing in step 410. In an embodiment, the haptic data generating device may split the audio data converted into the frequency domain for each frequency band and select a frequency band including a frequency in which a value subjected to the FFT processing is largest as the target frequency band. In step 430, the haptic data generating device may perform filtering for the target frequency band by using a bandpass filter.

In step 440, the haptic data generating device may perform inverse fast Fourier transform (IFFT) processing for the audio data in a target frequency band in which filtering in step 430 is performed. Through the IFFT processing, data may be converted into the time domain from the frequency domain.

In step 450, the haptic data generating device may perform threshold and addition processing in the result of performing the IFFT processing in step 440. The haptic data generating device may extract data values of a threshold or more from the data converted into the time domain and then, add the extracted data values in units of specific time interval. In step 460, the haptic data generating device may determine the haptic pattern based on a threshold and addition processing result in step 450. The haptic data generating device may determine the haptic pattern by determining that the haptic effect occurs when an addition result of the data values determined in step 450 satisfies a specific condition.

As such, it is possible to provide the haptic effect by processing the audio data for each event without setting the haptic effect separately for each event.

FIG. 5 is a diagram illustrating elements of haptic data according to an embodiment.

According to an embodiment, the haptic data may include information on the haptic pattern index and the haptic strength and may include various information as shown in Table 3 below.

TABLE 3

| No | Element | Description |
|---|---|---|
| 1 | Tag | Message start indication, 0x47 |
| 2 | Length | Side~Strength length |
| 3 | Side | Channel information of actuator |
| 4 | Pattern index | Haptic pattern index |
| 5 | Strength | Haptic strength |

Meanwhile, the haptic data may be constructed in a message format illustrated in FIG. 5 and transmitted to the haptic effect providing device. The embodiment of FIG. 5 illustrates an example in which the haptic data is constructed in a Basic Encoding Rules (BER) method (LTV notation) which is an encoding rule of Abstract Syntax Notation Number One (ASN.1). Referring to FIG. 5, the haptic data may be transmitted in a message format including elements such as a tag which is a first element, a length which is a second element, and a value of a third element. The element ‘tag’ indicates the type of message. In an embodiment, when 0x47 (ASCII code:, ‘G’) is designated in the ‘tag’, it may be determined that information on the haptic pattern is included in the message. In the element of ‘length’, the size of the message value may be expressed as bytes. When the size of the message value is more than 255 (0xFF) bytes, a value of 0x81 may be added to the front according to the BER method. For example, in the case of 260 bytes, the ‘length’ may be designated ‘0x81 0x01 0x04’. The element of ‘value’ includes information on the message. The element of ‘value’ may include information on actual haptic data. For example, the element ‘value’ may include information on the haptic pattern index and the haptic strength.

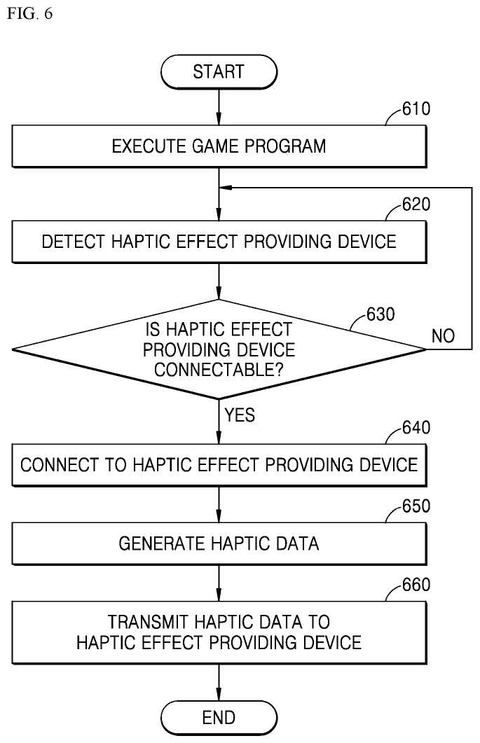

FIG. 6 is a flowchart for describing an operation of a method for generating haptic data according to an embodiment. The haptic data generating method may be performed by the haptic data generating device described in the present invention.

Referring to FIG. 6, in step 610, a game program is executed. A device (hereinafter, referred to as ‘executing device’) that executes the game program may detect the presence of the haptic effect providing device in step 620 and determine whether the haptic effect providing device is connectable in step 630. When the haptic effect providing device is connectable, the executing device is connected to the haptic effect providing device in step 640. The executing device may be connected to the haptic effect providing device through wireless communication using Bluetooth, BLE, Wi-Fi, LTE, etc., or wired communication through the cable. The executing device may include the haptic data generating device and in some embodiments, the haptic effect providing device may also be connected to the haptic data generating device.

In step 640, the haptic data generating device may generate the haptic data for the event which occurs during the game play based on the haptic data setting information. In an embodiment, the haptic data generating device may generate the haptic data based on the haptic data setting information including setting information for at least one of the application range of the haptic effect, the haptic pattern, and the haptic strength. The haptic data setting information may be determined by the user input and the user may select the application range of the haptic effect, the haptic pattern, and the haptic strength through the setting interface in the game program.

Even if not set by the user, the haptic data generating device may perform the fast Fourier transform processing for the audio data corresponding to each event, select a target frequency band of the audio data based on the result of performing the fast Fourier transform processing, perform filtering for the target frequency band by using the bandpass filter, perform the inverse fast Fourier transform processing for the audio data in the target frequency band in which the filtering is performed, and determine the haptic pattern based on the threshold in the result of performing the inverse fast Fourier transform processing. Furthermore, the haptic data generating device may extract a frequency in which the result value of performing the FFT processing for the audio data is largest and generate the haptic data corresponding to the event based on the haptic strength corresponding to the extracted frequency. The contents described through FIGS. 1 to 5 may be applied to the description that the haptic data generating device generates the haptic data and a description of redundant contents will be omitted.

In step 650, the haptic data generating device may transmit, to the haptic effect providing device, the haptic data generated in step 640.

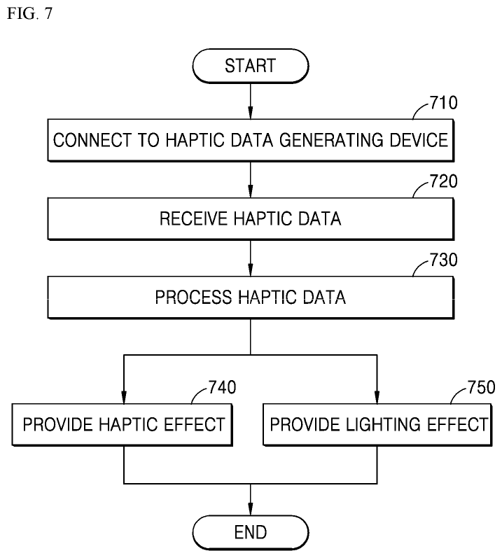

FIG. 7 is a flowchart for describing an operation of a method for providing a haptic effect according to an embodiment. The haptic effect providing method may be performed by the haptic effect providing device described in the present invention.

Referring to FIG. 7 in step 710, the haptic effect providing device is connected to the haptic data generating device (or the device that executes the game program). In step 720, the haptic effect providing device may receive, from the haptic data generating device, the haptic data associated with the event which occurs during the game play. In step 730, the haptic effect providing device may process the received haptic data and generate haptic pattern data. For example, the haptic effect providing device may generate the haptic pattern data for defining the haptic effect by using the information on the haptic pattern index and the haptic strength included in the haptic data.

In step 740, the haptic effect providing device provides the haptic effect to the user by generating the haptic effect based on the haptic pattern data. The haptic effect providing device may drive the actuator based on the haptic pattern data and a time at which each haptic pattern is provided may be processed according to the duration for each event corresponding to the haptic strength. That is, the duration may be determined according to the haptic pattern index (which is the same as the index for the event).

In some embodiments, in step 750, the haptic effect providing device may provide the lighting effect to the user by generating the lighting effect based on the haptic pattern data. The haptic effect providing device may generate the lighting effect based on the information on the haptic strength extracted from the haptic pattern data. For example, the haptic effect providing device may determine a color or a brightness of LED lighting by using the information on the haptic pattern index and the haptic strength included in the haptic pattern data and generate the lighting effect while the haptic effect is provided.

The contents described through FIGS. 1 to 2 may be applied to the description that the haptic effect providing device provides the haptic effect and/or the lighting effect and a description of redundant contents will be omitted.

The method according to the embodiment may be implemented in a form of a program command which may be performed through various computer means and recorded in the computer readable medium. The computer readable medium may singly or combinationally include a program command, a data file, or a data structure or a combination thereof. The program command recorded in the medium may be specially designed and configured for the embodiment, or may be publicly known to and used by those skilled in the computer software field. Examples of the computer-readable recording medium include magnetic media such as a hard disk, a floppy disk, and a magnetic tape, optical media such as a CD-ROM and a DVD, magneto-optical media such as a floptical disk, and a hardware device which is specifically configured to store and execute the program command such as a ROM, a RAM, and a flash memory. Examples of the program command include a high-level language code executable by a computer by using an interpreter, and the like, as well as a machine language code created by a compiler. The hardware device may be configured to be operated with one or more software modules in order to perform the operation of the embodiment and vice versa.

The software may include a computer program, code, instructions, or a combination of one or more thereof, and configure the processing unit to operate as desired, or instruct a processing device independently or collectively. Software and/or data may be interpreted by the processing device or may be permanently or temporarily embodied in any type of machine, component, physical device, virtual equipment, computer storage medium or device, or a transmitted signal wave in order to provide instructions or data to the processing device. The software may be distributed on a computer system connected through the network and stored or executed by a distributed method. The software and the data may be stored in one or more computer readable recording media.

As described above, although the embodiments have been described by the limited drawings, those skilled in the art can apply various technical modifications and variations based on the above. For example, the described techniques are performed in a different order from the described method, and/or components such as a system, structure, device, circuit, etc., described are collected or combined in a form different from the described method, or even if the components are replaced or substituted by other components or an equivalent, an appropriate result can be achieved.

Therefore, other implementations, other embodiments and claims and equivalents fall within the scope of the following claims.

1.-24. (canceled)

25. A haptic effect providing system linked with a game program, the system comprising:
a data generating device; and
a haptic effect providing device,
wherein the data generating device includes
a first controller generating data for an event which occurs during game play, and
a first communication unit transmitting the generated data to the haptic effect providing device,
the haptic effect providing device includes
a second communication unit receiving the data from the data generating device,
a second controller controlling generation of a haptic effect based on the received data and haptic data setting information, and
a haptic effect reproducing unit generating the haptic effect under the control of the second controller,
wherein, among the haptic data setting information, at least one of an application range of the haptic effect, a haptic pattern, and a haptic strength for the event is determined by a user input, and
wherein, when the haptic data setting information by the user input is not set, the data is generated based on an application range, a haptic pattern, and a haptic strength which are preset.

26. The haptic effect providing system of claim 25, wherein the event includes at least one of a game content event occurring on a game content of the game program and a user input event for a user input inputted for the game play.

27. The haptic effect providing system of claim 26, wherein the game content event includes an event which occurs by the user input event.

28. The haptic effect providing system of claim 25, wherein the haptic effect providing device contacts the data generating device to directly transfer the haptic effect to the data generating device.

29. The haptic effect providing system of claim 25, wherein when the data generating device is wiredly connected to the haptic effect providing device through a cable, the data generating device simultaneously receives data and power through the cable.

30. The haptic effect providing system of claim 25, wherein the haptic effect providing device as a haptic patch attachable to the data generating device does not include a means for autonomously supplying power and receives power used for driving an actuator of the haptic effect reproducing unit from the data generating device.

31. The haptic effect providing system of claim 25, wherein the data includes
a first element representing the type of a message,
a second element representing a size of a message value, and
a third element including message information.

32. The haptic effect providing system of claim 31, wherein the third element includes information on a haptic pattern index and the haptic strength.

33. The haptic effect providing system of claim 32, wherein the second controller generates haptic pattern data using information on the haptic pattern index and the haptic strength included in the data and controls the generation of the haptic effect based on the haptic pattern data.

34. The haptic effect providing system of claim 33, wherein the second controller generates the haptic pattern data based on a haptic pattern duration corresponding to the haptic pattern index.

35. The haptic effect providing system of claim 25, wherein the haptic effect providing device further includes a lighting effect reproducing unit generating a lighting effect under the control of the second controller, and
the second controller controls the generation of the lighting effect based on the data.

36. The haptic effect providing system of claim 35, wherein the second controller extracts the information on the haptic strength from the data and controls at least one of a lighting color and a lighting strength of the lighting effect displayed by the lighting effect reproducing unit based on the extracted information on the haptic strength.

37. The haptic effect providing system of claim 25, wherein the haptic effect providing device has any one form of a wearable device, a mobile device accessory device, a game pad, a keyboard, a mouse, and a joystick.

38. A method for generating and providing haptic data, which is linked with a game program, the method comprising:
generating, by a haptic data generating device, haptic data for an event occurring during game play based on haptic data setting information;
transmitting the generated haptic data to a haptic effect providing device;
generating, by the haptic effect providing device, haptic pattern data based on the haptic data; and
generating a haptic effect based on the haptic pattern data,
wherein, among the haptic data setting information, at least one of an application range of the haptic effect, a haptic pattern, and a haptic strength for the event is determined by a user input, and
when the haptic data setting information by the user input is not set, the haptic data is generated based on an application range, a haptic pattern, and a haptic strength which are preset.

39. A haptic effect providing device linked with a game program, the device comprising:
a communication unit receiving data from a data generating device;
a controller controlling generation of a haptic effect based on the received data and haptic data setting information; and
a haptic effect reproducing unit generating the haptic effect under the control of the controller,
wherein, among the haptic data setting information, at least one of an application range of the haptic effect, a haptic pattern, and a haptic strength for the event is determined by a user input, and
wherein, when the haptic data setting information by the user input is not set, the data is generated based on an application range, a haptic pattern, and a haptic strength which are preset.

40. The haptic effect providing device of claim 39, wherein the haptic effect providing device contacts the data generating device, and an actuator of the haptic effect reproducing unit directly transfers the haptic effect to the data generating device.

41. The haptic effect providing device of claim 39, wherein the haptic effect providing device is wiredly connected to the data generating device through a cable and simultaneously receives data and power through the cable.

42. The haptic effect providing device of claim 39, wherein the haptic effect providing device as a haptic patch attachable to the data generating device does not include a means for autonomously supplying power and receives power used for driving the actuator of the haptic effect reproducing unit from the data generating device.

43. The haptic effect providing device of claim 39, further comprising:
a lighting effect reproducing unit generating a lighting effect under the control of the controller,
wherein the controller controls the generation of the lighting effect based on the data.

44. The haptic effect providing device of claim 43, wherein the controller extracts the information on the haptic strength from the data and controls at least one of a lighting color and a lighting strength of the lighting effect displayed by the lighting effect reproducing unit based on the extracted information on the haptic strength.
